(19) United States
(12) Patent Application Publication
(10) Pub. No.: US 2005/0086123 A1
(43) Pub. Date: Apr. 21, 2005

(54) Method, system and program product for managing items available for electronic purchase

(75) Inventor: Russell T. White JR., Conklin, NY (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/688,006

(22) Filed: Oct. 17, 2003

(51) Int. Cl. G06F 17/60

(52) U.S. Cl. 705/26

(57) ABSTRACT

Method, system and program product for managing items available for electronic purchase. One or more high frequency items can be displayed on a high level page. The items can be located for display by automatically generating a query for each level of a hierarchical structure in which the items are stored. Additionally, one or more high frequency items can be presented to an administrator for a group of users who can select one or more of the high frequency items for display on a high level page presented to each user in the group of users.

### FIELD OF THE INVENTION

The invention relates generally to electronic purchases, and more specifically, to a method, system and program product for managing items available for electronic purchase.

### BACKGROUND OF THE INVENTION

In an electronic shopping environment, a user is often required to navigate one or more pages to access an item (i.e., product or service) that is desired for purchase. For example, items are often categorized in a hierarchical structure. The hierarchical structure can be navigated from the broadest to narrowest categories at which point the items located in the narrowest categories are displayed. Each time a narrower category is selected, a new page is displayed to the user that includes the details of the narrower category (i.e., additional categories, products, services, etc.).

For retailers that offer a wide range of items for purchase, the hierarchical structure can be time consuming to navigate, particularly for frequently purchased items. Several solutions exist to ease the navigation required to select frequently purchased items. For example, an item that is anticipated to be frequently purchased (e.g., a newly released, highly anticipated book) can be placed on the first page presented to a user. This allows the user to access the item while bypassing the hierarchical structure in which the item is located. Similarly, solutions have been provided that automatically determine the frequency that items are purchased, and automatically place the items most frequently purchased on higher pages.

However, in some environments, items cannot be readily placed on higher pages. For example, an item is often placed on a higher page by a link that directly accesses the page that includes the item details. In some environments, such a link cannot be created due to the way in which the data for items are stored and/or the pages are generated. For example, a query may be required to navigate each level of the hierarchical structure and the page may be dynamically generated based on the result of the query. In this case, a link cannot be generated to skip these queries and obtain the item directly. Alternatively, special program code can be written to obtain the particular item details. However, this solution is both time consuming and does not allow for a great deal of automation.

Further, frequently purchased items may differ among different groups of users. For example, one company may only purchase printer-related supplies from a web site, while another company may only purchase services related to security and privacy of its network from the same web site. Current solutions do not provide frequencies that discriminate between groups of users that may be purchasing items from a web site. Still further, the administrator(s) of a group of users (e.g., a purchase manager of a company) may desire that an item be placed at a higher page, even though other items are more frequently purchased. For example, an administrator may prefer that toner cartridges be placed at a higher page, despite the fact that printer paper is purchased more frequently.

As a result, a need exists for a method, system and program product for managing items available for electronic purchase. In particular, a need exists for a solution that automatically generates queries for each level of a hierarchical structure to display an item at a high level page. Further, a need exists for a solution that presents one or more items purchased frequently to an administrator that selects which, if any, high frequency items should be displayed on a high level page.

### SUMMARY OF THE INVENTION

The invention provides a method, system and program product for managing items available for electronic purchase. Specifically, under the present invention, an item that is frequently purchased electronically (i.e., a high frequency item) can be displayed on a high level page. In one embodiment, the items are stored in a hierarchical structure, and each of the items is located using a query for each level of the hierarchical structure. In order to display the high frequency item on a high level page, the query for each level of the hierarchical structure is automatically generated. In another embodiment, one or more high frequency items are presented to an administrator for a group of users. The administrator is then allowed to select which, if any, high frequency items will be displayed, and/or the high level page on which it will be displayed. As a result, the invention provides an improved solution for managing items available for electronic purchase, and in particular, the display of high frequency items to users.

A first aspect of the invention provides a method of managing items available for electronic purchase, the method comprising: storing the items in a hierarchical structure, wherein each of the items is located using a query for each level of the hierarchical structure; identifying at least one high frequency item; and automatically generating the query for each level of the hierarchical structure to display the at least one high frequency item on a high level page.

A second aspect of the invention provides a method of managing items available for electronic purchase, the method comprising: storing the items in a hierarchical structure, wherein each of the items is located using a query for each level of the hierarchical structure; identifying at least one high frequency item for a group of users; presenting the at least one high frequency item to an administrator for the group of users; and selecting at least one high frequency item for display on a high level page for each user in the group of users.

A third aspect of the invention provides a system for managing items available for electronic purchase, the system comprising: a storage system for storing the items in a hierarchical structure, wherein each of the items is located using a query for each level of the hierarchical structure; a frequency system for identifying at least one high frequency item; and a display system for displaying the at least one high frequency item on a high level page by automatically generating the query for each level of the hierarchical structure.

A fourth aspect of the invention provides a computer program product stored on a recordable medium for managing items available for electronic purchase, which when executed comprises: program code for storing the items in a hierarchical structure, wherein each of the items is located using a query for each level of the hierarchical structure; program code for identifying at least one high frequency item; and program code for displaying the at least one high frequency item on a high level page by automatically generating the query for each level of the hierarchical structure.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative hierarchical structure;

FIG. 2 shows an illustrative highest level page;

FIG. 3 shows an illustrative high level page; and

FIG. 4 shows an illustrative system for managing items available for electronic purchase according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

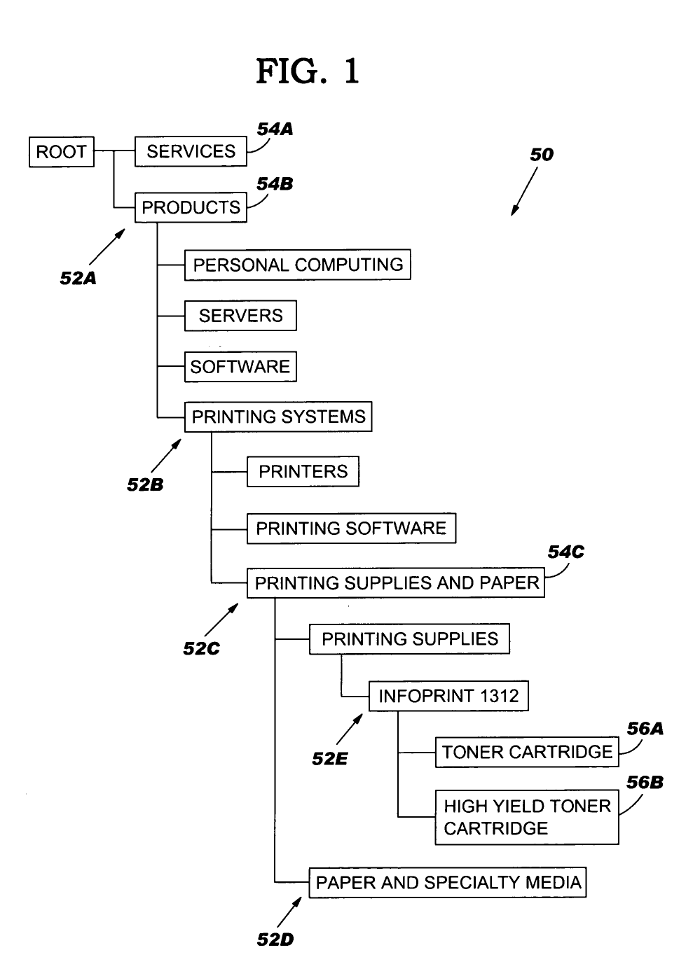

In general, the invention provides a solution for managing items available for electronic purchase that are stored in a hierarchical structure, in which one or more high frequency items can be displayed on a high level page. Turning to the drawings, FIG. 1 shows a partial view of an illustrative hierarchical structure 50 that can be used to store items 56A-B available for electronic purchase according to one embodiment of the invention. To navigate hierarchical structure 50, a user generally starts at a “highest level” 52A of hierarchical structure 50. Highest level 52A comprises the level of hierarchical structure 50 that includes the broadest (i.e., most inclusive) categories of items, e.g., services category 54A and products category 54B. Each succeeding level 52B-E comprises an increasingly specific category within the previous category until a “lowest level” 52E is reached. Lowest level 52E comprises the level of hierarchical structure 50 that includes items 56A-B that are available for purchase. Since each level above lowest level 52E includes at least one level below it, each of these levels comprises a “high level.” While hierarchical structure 50 is shown as a tree (i.e., each node has only one “parent” node) having a particular number of levels 52A-E, it is understood that any hierarchical structure is possible. To this extent, items 56A-B and/or categories 54A-C could have multiple “parent” levels 52A-E, and consequently numerous paths could be followed to obtain items 56A-B.

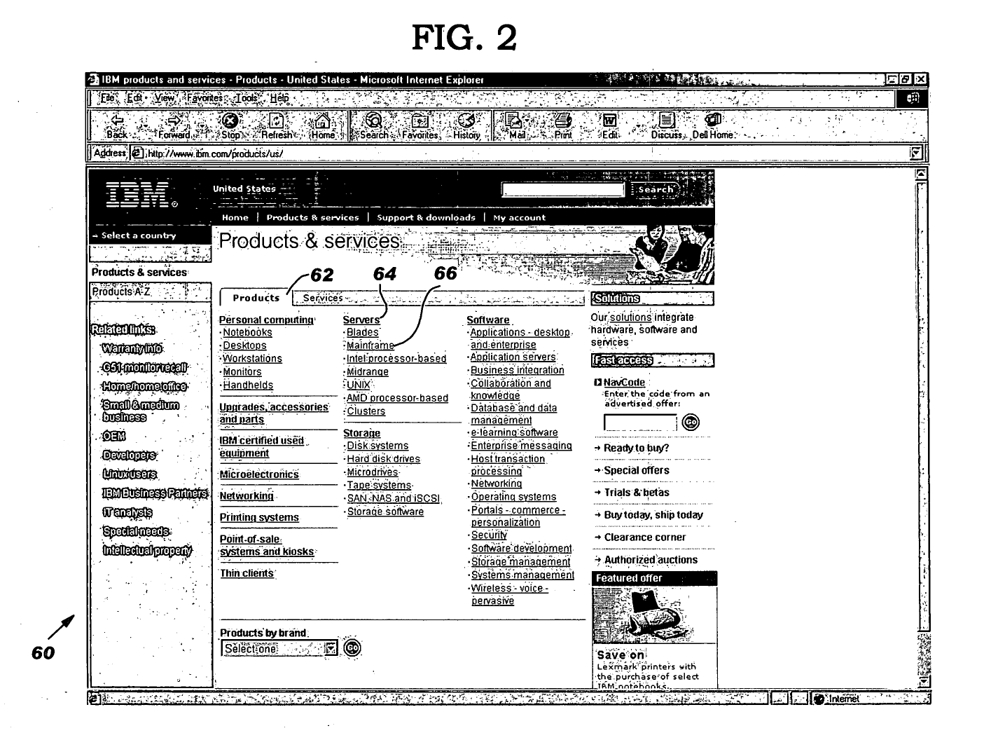

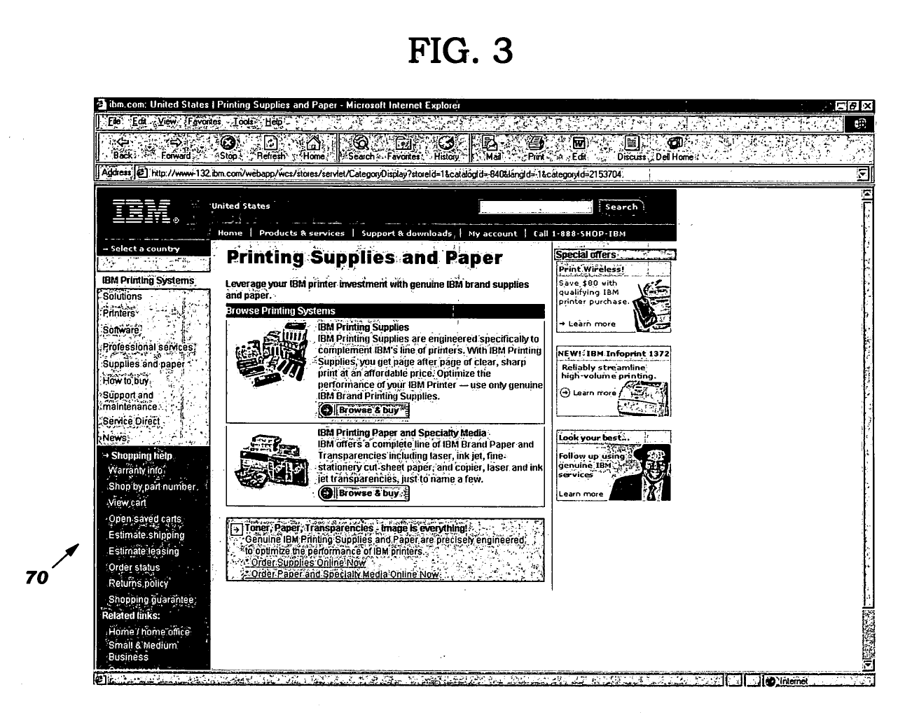

A hierarchy of pages (e.g., web pages) can be used to navigate hierarchical structure 50. The hierarchy of pages can be based on hierarchical structure 50. Consequently, when a user accesses, for example, a web site having one or more items 56A-B available for purchase, some or all of hierarchical structure 50 can be displayed using the hierarchy of pages. For example, FIG. 2 shows an illustrative web page 60 for purchasing one or more items 56A-B (FIG. 1) stored in hierarchy 50 (FIG. 1). Similar to level 52A, web page 60 comprises a “highest level page” since it is the initial page displayed to the user, and the user can select which category 54A-B (FIG. 1) within highest level 52A to narrow. In this case, the user selectively moves to successively lower level pages until being provided with a “lowest level page” that includes item(s) 56A-B. A “high level page” comprises any page along the hierarchy of pages on which items 56A-B would not normally appear (i.e., any page other than a lowest level page). For example, FIG. 3 shows an illustrative high level page 70 that corresponds to category 54C (FIG. 1), i.e., “printing supplies and paper.” As shown, high level page 70 includes two selections for categories located in level 52D (FIG. 1), below category 54C, i.e., “printing supplies” and “paper and specialty media.”

Returning to FIG. 2, highest level page 60 can be configured to include some or all of the categories for one or more levels 52B-E below highest level 52A. For example, web page 60 includes tabs 62 for selecting categories 54A-B from highest level 52A, bold entries 64 for selecting a category from level 52B, and entries 66 below the corresponding bold entry 64 for selecting a category from level 52C. Consequently, while the hierarchy of pages is based on hierarchical structure 50, the two do not necessarily correspond in a one-to-one manner.

As indicated above, the invention provides a method, system and program product for managing items available for electronic purchase. Specifically, under the present invention, an item that is frequently purchased electronically (i.e., a high frequency item) can be displayed on a high level page. In one embodiment, the items are stored in a hierarchical structure, and each of the items is located using a query for each level of the hierarchical structure. In order to display the high frequency item on a high level page, the query for each level of the hierarchical structure is automatically generated. In another embodiment, one or more high frequency items are presented to an administrator for a group of users. The administrator is then allowed to select which, if any, high frequency items will be displayed, and/or the high level page on which it will be displayed. As a result, the invention provides an improved solution for managing items available for electronic purchase, and in particular, the display of high frequency items to users.

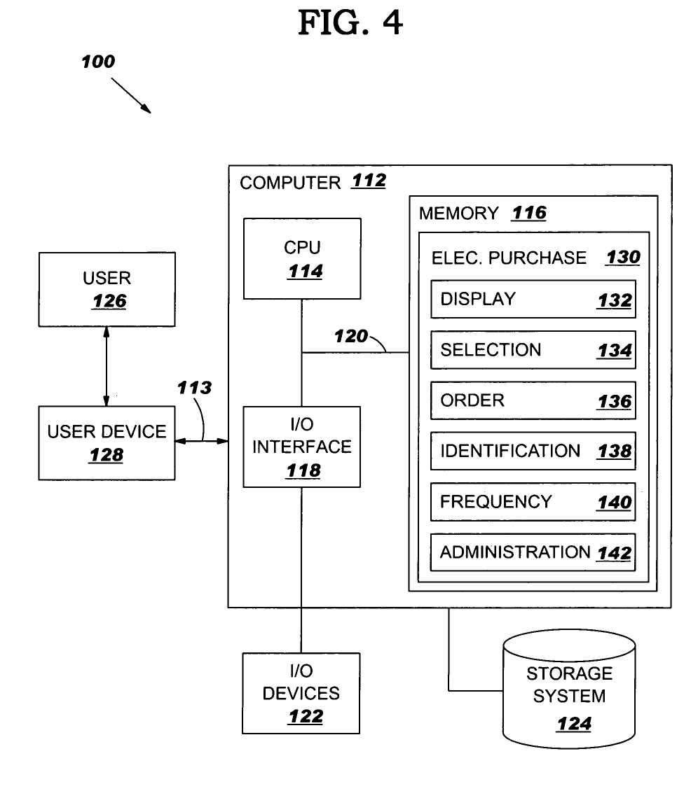

FIG. 4 shows an illustrative system 100 for managing items available for electronic purchase according to one embodiment of the invention. As depicted, user 126 operates user device 128 to select an item for purchase. User device 128 communicates with computer 112 via communications link 113 to request the electronic purchase. To this extent, communications link 113 can comprise a direct hardwired connection (e.g., serial port), or another type of network connection. In the case of the latter, the network can comprise an addressable connection in a client-server (or server-server) environment that may utilize any combination of wireline and/or wireless transmission methods. In this instance, the server and client may utilize conventional network connectivity, such as Token Ring, Ethernet, WiFi or other conventional communications standards. Further, the network can comprise any type of network, including the Internet, a wide area network (WAN), a local area network (LAN), a virtual private network (VPN), etc. Where the client communicates with the server via the Internet, connectivity could be provided by conventional TCP/IP sockets-based protocol, and the client would utilize an Internet service provider to establish connectivity to the server.

As shown, computer 112 generally includes central processing unit (CPU) 114, memory 116, input/output (I/O) interface 118, bus 120, external I/O devices/resources 122, and a storage system 124. CPU 114 may comprise a single processing unit, or be distributed across one or more processing units in one or more locations, e.g., on a client and server. Memory 116 may comprise any known type of data storage and/or transmission media, including magnetic media, optical media, random access memory (RAM), read-only memory (ROM), a data cache, a data object, etc. Storage system 124 may comprise any type of data storage for providing more static storage of data used in the present invention (e.g., hierarchical structure 50 shown in FIG. 1). As such, storage system 124 may include one or more storage devices, such as a magnetic disk drive or an optical disk drive. Moreover, similar to CPU 114, memory 116 and/or storage system 124 may reside at a single physical location, comprising one or more types of data storage, or be distributed across a plurality of physical systems in various forms. Further, memory 116 and/or storage system 124 can include data distributed across, for example, a LAN, WAN or a storage area network (SAN) (not shown).

I/O interface 118 may comprise any system for exchanging information to/from an external source. I/O devices 122 may comprise any known type of external device, including speakers, a CRT, LED screen, handheld device, keyboard, mouse, voice recognition system, speech output system, printer, monitor/display, facsimile, pager, etc. Bus 120 provides a communication link between each of the components in computer 112 and likewise may comprise any known type of transmission link, including electrical, optical, wireless, etc. In addition, although not shown, additional components, such as cache memory, communication systems, system software, etc., may be incorporated into computer 112.

Further, user device 128 typically includes the same elements as shown in computer 112 (e.g., CPU, memory, I/O interface, etc.). These have not been separately shown and discussed for brevity. It is understood that computer 112 and user device 128 comprise any type of computing devices capable of communicating with one or more other computing devices. For example, computer 112 and user device 128 could comprise any combination of a server, a client, a desktop computer, a laptop, a handheld device, a mobile phone, a pager, a personal data assistant, etc. It is understood, however, that if computer 112 or user device 128 is a handheld device or the like, a display could be contained within computer 112 or user device 128, and not as an external I/O device 122 as shown for computer 112.

Shown stored in memory 116 is an electronic purchase system 130 that allows user 126 to purchase one or more items electronically, for example, via the Internet. Electronic purchase system 130 is shown including a display system 132, a selection system 134, an order system 136, an identification system 138, a frequency system 140, and an administration system 142. While these systems are shown implemented as part of electronic purchase system 130, it is understood that some or all of the systems can be implemented independently, combined, and/or stored in memory for one or more separate computers 112 that communicate over a network.

In general, display system 132 displays items available for electronic purchase on user device 128 for user 126 (e.g., in a browser). User 126 can operate user device 128 to navigate hierarchical structure 50 (FIG. 1) that classifies the various items using a hierarchy of pages, and select an item for purchase using selection system 132. After all desired items are selected, user 126 can select to complete the purchase using order system 136. Each time an item is purchased, frequency system 140 can maintain the frequency with which the item is purchased. Frequency system 140 can identify one or more high frequency items (i.e., items that are frequently purchased), and display system 132 can display the one or more high frequency items on a high level page. For example, frequency system 140 can keep track of the ten most frequently purchased items.

At some point during the electronic purchase, identification system 138 can obtain identification information from user 126. For example, user 126 may provide a user name and password to identification system 138, identification system 138 can read identification information stored in a “cookie” or the like on user device 128, etc. In any event, once user 126 has been identified, identification system 138 can determine if user 126 belongs to a group of users. Frequency system 140 can maintain separate frequencies for each of a plurality of groups of users. In this case, frequency system 140 can identify one or more items that are frequently purchased by the group of users to which user 126 belongs, and display system 132 can display the one or more items on a high level page. As a result, a particular high level page for two groups of users could have different high frequency item(s) displayed. To this extent, groups can be any grouping of users such as two departments in a single company, two separate companies, etc.

Further, user 126 can be identified as an administrator or the like for one of the groups of users. In this case, administration system 142 can present one or more high frequency items to user 126 (i.e., the administrator). User 126 can use administration system 142 to select one or more of the high frequency items to be displayed on a high level page for each user in the group of users. Further, user 126 can use administration system 142 to select the particular high level page to display one or more of the high frequency items. For example, item 56A (FIG. 1), a toner cartridge, and item 56B (FIG. 1), a high yield toner cartridge, may both be frequently purchased by a group of users. An administrator may only want to make item 56B, the high yield toner cartridge, available on a high level page since it is preferred that users purchase item 56B rather than item 56A. Additionally, the administrator may select to display item 56B on high level page 70 (FIG. 3) rather than on highest level page 60 (FIG. 2) so that it is more likely that user 126 is seeking printing supplies and/or paper.

An administrator can also use administration system 142 and/or frequency system 140 to define an item as a high frequency item. For example, the group of users may have only been purchasing item 56A. Item 56B may be a new product that the administrator prefers the group of users to purchase instead of item 56A. In this case, the administrator can define item 56B as a high frequency item and select a high level page on which it will be displayed.

Returning to FIG. 1, each item 56A-B can be located using a query for each level 52A-E of hierarchical structure 50 above the item 56A-B. In order to locate items 56A-B, separate queries would be required for each of levels 52A-E. Further, each of these queries may need to be automatically generated in order to display items 56A-B on a high level page (e.g., highest level page 60 (FIG. 2)). In one embodiment, display system 132 (FIG. 4) dynamically determines each of the queries based on the item to be displayed. For example, administration system 142 (FIG. 4) can be used to designate that item 56B is to be displayed on highest level page 60 (FIG. 2). Administration system 142 can add a data entry in storage system 124 (FIG. 4) that includes one or more attributes of item 56B and identifies highest level page 60 on which item 56B is to be displayed. When display system 132 displays highest level page 60, display system 132 can obtain the data entry from storage system 124, and the data entry can be used to determine each of the queries required to locate item 56B. In an alternative embodiment, the data entry in storage system 124 could include each of the required queries. In this case, display system 132 can obtain the data entry, and locate item 56B using the stored queries.

In another embodiment, the operations performed by user 126 (FIG. 4) to select an item 56A-B in hierarchical structure 50 can be stored in storage system 124 by selection system 134. Frequency system 140 (FIG. 4) can analyze the stored operations to identify high frequency items. For example, each item 56A-B may have a unique last operation that is performed in order to locate a particular item 56A-B. In this case, frequency system 140 can determine the last operation for each of the stored operations, and count the number of unique operations that correspond to each item 56A-B.

The stored operations can also be used by administration system 142 and/or display system 132 to determine the path that users 126 typically follow in selecting items 56A-B. The path can be used to determine an appropriate high level page on which to display a high frequency item. For example, users 126 may be capable of accessing item 56B through two high level pages that correspond to level 52B, for example, printing systems or personal computing. However, users 126 that select item 56B for purchase may locate item 56B through the printing systems page far more frequently than through the personal computing page. Consequently, item 56B can be displayed on the printing systems page, and not on the personal computing page.

Still further, display system 132 (FIG. 4) can obtain the query for each level 52A-E based on the stored operations. For example, each stored operation can include a category 54A-C selected by user 126 and its corresponding level 52A-E. Consequently, display system 132 can select the operations from the broadest level 52A to the narrowest level 52E, and a query can be generated that selects the appropriate category 54A-C for each level 52A-E. Alternatively, each stored operation can comprise the particular query that was performed for each level 52A-E. In this case, display system 132 can use the stored queries to locate items 56A-B.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing items available for electronic purchase, the method comprising:
storing the items in a hierarchical structure, wherein each of the items is located using a query for each level of the hierarchical structure;
identifying at least one high frequency item; and
automatically generating the query for each level of the hierarchical structure to display the at least one high frequency item on a high level page.

2. The method of claim 1, further comprising:
presenting the at least one high frequency item to an administrator; and
selecting at least one high frequency item for display on the high level page.

3. The method of claim 1, further comprising storing the operations performed by a user to select an item in the hierarchical structure.

4. The method of claim 3, wherein the identifying step includes analyzing the stored operations.

5. The method of claim 3, wherein the automatically generating step includes obtaining the query for each level based on the stored operations.

6. The method of claim 1, further comprising maintaining the frequency that each of the items has been purchased.

7. The method of claim 6, wherein a separate frequency is maintained for each of a plurality of groups of users.

8. A method of managing items available for electronic purchase, the method comprising:
storing the items in a hierarchical structure, wherein each of the items is located using a query for each level of the hierarchical structure;
identifying at least one high frequency item for a group of users;
presenting the at least one high frequency item to an administrator for the group of users; and
selecting at least one high frequency item for display on a high level page for each user in the group of users.

9. The method of claim 8, further comprising automatically generating the query for each level of the hierarchical structure to display the selected at least one high frequency item on the high level page.

10. The method of claim 8, further comprising separately maintaining frequencies that each of the items has been purchased for a plurality of groups of users.

11. The method of claim 8, further comprising storing the operations performed by a user to select an item in the hierarchical structure.

12. The method of claim 11, wherein the identifying step includes analyzing the stored operations.

13. The method of claim 11, wherein the automatically generating step includes obtaining the query for each level based on the stored operations.

14. A system for managing items available for electronic purchase, the system comprising:
a storage system for storing the items in a hierarchical structure, wherein each of the items is located using a query for each level of the hierarchical structure;
a frequency system for identifying at least one high frequency item; and
a display system for displaying the at least one high frequency item on a high level page by automatically generating the query for each level of the hierarchical structure.

15. The system of claim 14, further comprising a selection system for selecting an item in the hierarchical structure, and storing the operations performed to select the item.

16. The system of claim 14, wherein the frequency system separately maintains frequencies that each of the items has been purchased for each of a plurality of groups of users.

17. The system of claim 14, further comprising an administration system for allowing an administrator for a group of users to select at least one high frequency item for display on the high level page.

18. The system of claim 14, further comprising an identification system for identifying a user.

19. A computer program product stored on a recordable medium for managing items available for electronic purchase, which when executed comprises:
program code for storing the items in a hierarchical structure, wherein each of the items is located using a query for each level of the hierarchical structure;
program code for identifying at least one high frequency item; and
program code for displaying the at least one high frequency item on a high level page by automatically generating the query for each level of the hierarchical structure.

20. The program product of claim 19, further comprising program code for selecting an item in the hierarchical structure, and storing the operations performed to select the item.

21. The program product of claim 19, further comprising program code for separately maintaining frequencies that each of the items has been purchased for each of a plurality of groups of users.

22. The program product of claim 19, further comprising program code for allowing an administrator for a group of users to select at least one high frequency item for display on the high level page.
